(19) United States
(12) Patent Application Publication
(10) Pub. No.: US 2025/0230182 A1
(43) Pub. Date: Jul. 17, 2025

(54) A METHOD FOR PURIFYING LIGNIN

(71) Applicant: Stora Enso OYJ, Helsinki (FI)

(72) Inventors: Rickard Wadsborn, Rönninge (SE); Maria Björk, Karlstad (SE); Lasse Tolonen, Stockholm (SE); Åsa Samuelsson, Stockholm (SE); Marcelo Hamaguchi, Lappeenranta (FI)

(73) Assignee: Stora Enso OYJ, Helsinki (FI)

(21) Appl. No.: 18/855,664

(22) PCT Filed: Apr. 11, 2023
(86) PCT No.: PCT/IB2023/053663

§ 371 Date: Oct. 10, 2024

(30) Foreign Application Priority Data
Apr. 11, 2022 (SE) 2230107-1

(51) Int. Cl. C07G 1/00; C08H 7/00

(52) U.S. Cl. CPC C07G 1/00; C08H 6/00

(57) ABSTRACT

The present invention relates to a method for purifying lignin. The method comprises the steps of: providing alkaline black liquor; removing inorganic impurities from the black liquor to obtain purified black liquor; acidifying the purified black liquor to precipitate lignin; separating the precipitated lignin from the acidified purified black liquor; mixing the precipitated lignin with an acidic solution so as to remove inorganic impurities from the precipitated lignin and obtain purified lignin; and separating the obtained purified lignin from the acidic solution. The content of inorganic impurities in the purified lignin is reduced by the method according to the present invention.

### FIELD OF THE INVENTION

The present invention relates to a method for purifying lignin involving removing inorganic impurities, such as metals and other inorganics, from black liquor prior to precipitation of lignin from said black liquor. The obtained purified lignin thus comprises low levels of inorganic impurities and is suitable for use in applications where a pure lignin is required.

### BACKGROUND

Lignin is an aromatic polymer, which is a major constituent in e.g. wood and one of the most abundant carbon sources on earth. In recent years, with development and commercialization of technologies to extract lignin in a purified, solid and particularized form from the pulp-making process, it has attracted significant attention as a possible renewable substitute to primarily aromatic chemical precursors currently sourced from the petrochemical industry.

Today, the most commercially relevant source of lignin is Kraft lignin. This lignin is obtained from hardwood or softwood through the kraft process. The lignin can be separated from alkaline black liquor using for example membrane-or ultrafiltration. LignoBoost is one common separation process and is described in WO2006031175 A1. In this process lignin is precipitated from alkaline black liquor through reducing the pH level, usually by adding carbon dioxide, and then filtered off. The lignin filter cake is in the next step re-slurried under acidic conditions, commonly using sulfuric acid, and washed. The precipitated washed lignin can be used as it is or further dried.

Black liquor is readily available as a by-product from the kraft process and is thus a cost-efficient lignin source. Black liquor contains a certain amount of inorganic impurities, mostly originating from wood and cooking chemicals used during the pulping process. It is assumed that inorganic impurities can be present in the black liquor as dissolved ions, precipitated in the form of salts, or in complexes with lignin. The exact form and distribution of all inorganic impurities in black liquor is however not known. Inorganic impurities will be present also in lignin precipitated from the black liquor. In many potential high-end applications, such as in biobinders, biofuels and for conversion of lignin to carbon enriched materials such as carbon fibers and carbon powders, it is important that the lignin used is as pure as possible, in particular with regards to the amount of inorganic impurities.

Some inorganic impurities, such as sodium and potassium, can to a large extent be removed from precipitated lignin by acidic washing during the separation process. Other inorganic impurities, such as aluminum, calcium, iron, manganese, magnesium, zinc, silicon and phosphorus, are however harder to remove from the precipitated lignin and consequently the total content of inorganic impurities in the obtained lignin after washing may still be too high for many high-end applications.

Various attempts of removing metals and other inorganics from lignin have been made. Common for these methods is that they are rather complex involving many additional processing steps; and/or that they are not sufficiently efficient in their removal efficiency.

WO2020013752 A1 discloses a method where lignin is dissolved in an acidic aqueous solvent. Through phase separation a two-phase system is obtained, where one phase is a lignin rich phase, and the other phase is poor in lignin and comprises metal cations extracted from lignin. However, many additional processing steps are required.

Thus, there is a need for a method for purifying lignin where the obtained purified lignin has a content of inorganic impurities that is sufficiently low so that the purified lignin can be used also in applications where a material of high purity is required. In addition, the method should not add to the complexity and cost of the lignin manufacturing process and no new or additional chemicals should be introduced into the lignin manufacturing process.

### SUMMARY OF THE INVENTION

It is an object of the present invention to provide an improved method for obtaining purified lignin, which method eliminates or alleviates at least some of the disadvantages of the prior art methods.

It is a further object of the present invention to provide a method for obtaining purified lignin, wherein the obtained lignin has a sufficiently low content of inorganic impurities so that it can be used also in applications where a low amount of inorganic impurities is required, such as the starting material for carbon enriched materials intended for use in energy storage applications.

It is a further object of the present invention to provide a method for obtaining purified lignin which method does not add to the complexity of the lignin manufacturing method.

The above-mentioned object, as well as other objects as will be realized by the person skilled in the art in light of the present invention, are achieved by the various aspects of the present invention.

According to a first aspect, the present invention is directed to a method for obtaining a purified lignin, wherein the method comprises the following steps:
a) providing alkaline black liquor;
b) removing inorganic impurities from the black liquor so as to obtain purified black liquor;
c) acidifying the purified black liquor to a pH value in the range of from 9 to 11 so as to precipitate lignin;
d) separating the precipitated lignin from the acidified purified black liquor;
e) mixing the precipitated lignin with an acidic solution so as to remove inorganic impurities from the precipitated lignin and obtain purified lignin; and
f) separating the obtained purified lignin from the acidic solution.

The inventive method according to the first aspect is based on the surprising realization that a purified lignin, having a reduced content of inorganic impurities, can be obtained by removing inorganic impurities from black liquor prior to precipitation of lignin from said black liquor. As the content of inorganic impurities in the black liquor is decreased, the amount of such species that can be enriched in the lignin during precipitation is also decreased. After precipitation of lignin and subsequent separation, the obtained precipitated lignin is mixed with an acidic solution in order to remove additional inorganic impurities from the precipitated lignin. After separation, a purified lignin is obtained. In particular, the amounts of inorganic impurities, such as aluminum, calcium, iron, magnesium, manganese, zinc, phosphorous and silica, that are typically hard to remove from lignin can be reduced by the inventive method. The obtained purified lignin with a reduced content of inorganic impurities is suitable for use in applications where a pure lignin is required.

### DETAILED DESCRIPTION

It is intended throughout the present description that the term “lignin” refers to any kind of lignin. Examples of said lignin are, but are not limited to, lignin obtained from vegetable raw material such as wood, e.g. softwood lignin, hardwood lignin, and lignin from annular plants. The lignin in the present invention is obtained by precipitation from alkaline black liquor. Preferably, lignin used in the method of the present invention is Kraft lignin, i.e. lignin obtained through the Kraft process. Preferably, the Kraft lignin is obtained from hardwood or softwood. The lignin may also be obtained from processes such as steam explosion or acidic pre-treatment followed by enzymatic hydrolysis.

The term “precipitation” as used herein refers to a process of separating lignin from black liquor. When the pH of the black liquor is decreased so that it becomes less alkaline, dissolved lignin will become less soluble and precipitate. Precipitated lignin forms aggregates that can be separated from the black liquor, typically by filtration. Depending on factors such as temperature and ionic strength of the black liquor, molecular weight of lignin, charged groups on the lignin, concentration of lignin in the black liquor and type of lignin, lignin will precipitate at different pH values.

The term “acidifying” as used herein refers to a process of lowering the pH value of a solution, in this case the alkaline black liquor. The pH of the solution may however still be alkaline, i.e. above 7, even after the acidifying process.

According to a first aspect, the present invention is directed to a method for purifying lignin. Step a) of the method according to the first aspect involves providing alkaline black liquor. The term “black liquor” as used herein refers to the liquid remaining after digestion of wood and separation of cellulose fibers in an alkaline chemical pulping process, such as a kraft process. The black liquor is strongly alkaline, such that the black liquor has a pH value above 13. The solid content of the black liquor provided in step a) is typically 30-40 wt %. Black liquor comprises dissolved lignin, that can be separated from black liquor by several different means, such as precipitation and filtration. In addition to lignin, the black liquor also comprises other extractives from wood such as hemicellulose, fatty acids, cellulose fractions as well as inorganics. Roughly one-third of the black liquor is composed of inorganics, whereas the remaining two-thirds are composed of organic material.

The term “inorganic impurities” as used herein, refers to inorganic elements, such as metals and other inorganic species, that are present in the black liquor. The amount of inorganic impurities in the black liquor may vary depending on for example the wood raw material and the pulping process used. In general, the black liquor comprises high levels of sodium and potassium, as well as lower amounts of metals such as aluminum, calcium, iron, magnesium, manganese, and zinc. The black liquor may also comprise trace amounts of other metals. In addition to metals, the black liquor typically comprises inorganics such as phosphorus and silicon.

Step b) of the method according to the first aspect involves removing inorganic impurities from the black liquor so as to obtain purified black liquor. The term “purified black liquor” as used herein refers to black liquor from which inorganic impurities have been removed. The total content of inorganic impurities in the purified black liquor is thus lower than that in the original black liquor. In one embodiment, the amounts of inorganic impurities such as aluminum, calcium, iron, magnesium, manganese, phosphorous, silica and zinc in the black liquor are reduced by the method according to the first aspect.

During precipitation of lignin from black liquor, it is assumed that inorganic impurities present in the black liquor may become entrapped in or form complexes with the precipitated lignin and may thus remain within the lignin agglomerates after precipitation. Inorganic impurities may thus be enriched in lignin during precipitation. By removing inorganic impurities from the black liquor prior to precipitation of lignin, the amount of inorganic impurities in the precipitated lignin can be reduced.

In one embodiment, the step of removing inorganic impurities from black liquor involves microfiltration or ultrafiltration of the black liquor. By filtering the black liquor through a filter, inorganic impurities in the form of salt particles can be removed from the black liquor, thus providing purified black liquor. In a preferred embodiment, the step of removing inorganic impurities from black liquor involves microfiltration of the black liquor.

In one embodiment, the step of removing inorganic impurities from the black liquor comprises contacting the black liquor with a pre-precipitated lignin fraction so as to remove inorganic impurities from black liquor to the pre-precipitated lignin. The term “pre-precipitated lignin” as used herein refers to a certain fraction of lignin that has been precipitated from black liquor using a higher pH than when precipitating the remaining lignin fraction. The pre-precipitated lignin normally constitutes a smaller fraction than the remaining lignin fraction in the black liquor, depending on the pH during pre-precipitation. At a lower pH, a larger fraction of lignin is precipitated, and the pre-precipitated lignin fraction will become larger. Generally, the pre-precipitated lignin will have a higher molecular weight than the lignin in the remaining fraction.

In one embodiment, the pre-precipitated lignin fraction is obtained by acidifying the black liquor to a pH value in the range of from 11 to 13, wherein the pH value used for acidifying the black liquor is higher than the pH value used for acidifying the purified black liquor in step c) of the method according to the first aspect. Any suitable acid can be used for the acidification of the black liquor. In one embodiment, the acidification of the black liquor is performed by adding carbon dioxide to the black liquor.

By contacting the black liquor with a pre-precipitated lignin fraction, the amount of inorganic impurities in the black liquor can be reduced. Without being bound by any theory, it is assumed that inorganic impurities in the form of solid salts can be separated from the black liquor along with the pre-precipitated lignin. Inorganic impurities in the black liquor may also be entrapped in the pre-precipitated lignin during the pre-precipitation process itself. These inorganic impurities can be separated along with the pre-precipitated lignin fraction so as to remove them from the black liquor, thus obtaining a purified black liquor.

The term “contacting” as used herein, refers to the process of putting the pre-precipitated lignin fraction in contact with the black liquor. By contacting the black liquor with a pre-precipitated lignin fraction, inorganic impurities are removed from the black liquor to the pre-precipitated lignin. Contacting may for example involve processes such as filtration and centrifugation.

In one embodiment, contacting the black liquor with the pre-precipitated lignin fraction comprises filtering the black liquor through the pre-precipitated lignin fraction. When the black liquor comprising the pre-precipitated lignin fraction is filtered, the pre-precipitated lignin fraction will form a layer on the filter and the pre-precipitated lignin fraction will act as an additional filter for the black liquor.

The pre-precipitated lignin fraction may be precipitated from black liquor just prior to or simultaneously with filtration of the black liquor, so that the layer of the pre-precipitated lignin fraction is formed on the filter during filtration of the black liquor after acidification. Alternatively, a pre-formed layer of a pre-precipitated lignin fraction may be applied to the filter prior to acidification and filtration of the black liquor. The pre-formed layer of a pre-precipitated lignin fraction may be obtained from a previous separation process involving a pre-precipitation step. Following acidification of the black liquor, additional pre-precipitated lignin will be deposited on the pre-formed layer on the filter during filtration of the black liquor.

By removing inorganic impurities by contacting black liquor with a pre-precipitated lignin fraction, an efficient way of reducing the content of inorganic impurities in black liquor is provided, as only commonly used equipment is employed. In addition, no additional chemicals are needed. This facilitates integration with existing processing lines.

In one embodiment, the step of removing inorganic impurities from black liquor involves centrifuging the black liquor. By centrifuging the black liquor, inorganic impurities in the form of salt particles can be removed from the black liquor, thus providing purified black liquor.

It is also within the scope of the present invention to use more than one means for removing inorganic impurities from the black liquor. The means defined above may thus be combined in any suitable combination. For example, the black liquor may first be filtered using microfiltration followed by a step of contacting the black liquor with a pre-precipitated lignin fraction.

Step c) of the method according to the first aspect involves acidifying the purified black liquor to a pH in the range of from 9 to 11 so as to precipitate lignin. In this step, the pH is lowered to a lower pH than in the pre-precipitation step, as further discussed above. Thus, a larger amount of lignin will typically precipitate in step c) as compared to the pre-precipitation step, if performed. By lowering the pH to a value in the range of from 9 to 11, a large fraction of lignin in the purified black liquor is precipitated. Any suitable acid can be used for the acidification of the purified black liquor. In one embodiment, acidification of the purified black liquor is performed by adding carbon dioxide to the black liquor.

Step d) of the method according to the first aspect involves separating the precipitated lignin from the acidified purified black liquor. The term “separation” as used herein, refers to the process of separating precipitated lignin from a liquid, such as from the acidified purified black liquor. In the present invention, purified lignin is also separated from an acidic solution, as further discussed below in relation to step f). In the separation process, the precipitated lignin is collected and can be further treated or processed. In a preferred embodiment, the separation involves filtration of the acidified purified black liquor. A filter press or any other suitable equipment as known by a person skilled in the art may be used for the filtration. In this embodiment, the precipitated lignin forms a filter cake. In an alternative embodiment, the separation may involve centrifuging.

Step e) of the method according to the first aspect involves mixing the precipitated lignin with an acidic solution so as to remove inorganic impurities from the precipitated lignin and obtain purified lignin. In addition, any remaining black liquor is also removed from the precipitated lignin. In a preferred embodiment, the acidic solution has a pH value in the range of from 2 to 4. The acidic solution may comprise any suitable acid. In one embodiment, the acidic solution comprises sulfuric acid. When mixing the precipitated lignin with an acidic solution, additional inorganic impurities, that were not removed by purification of the black liquor in step b), are removed from the precipitated lignin to the acidic solution. The amount of inorganic impurities in the precipitated lignin is thus reduced. In particular, the amounts of water-soluble inorganic impurities such as potassium and sodium are reduced in step e).

By combining the step of removing inorganic impurities from the black liquor and the step of mixing the precipitated lignin with an acidic washing solution, a purified lignin having a low total content of inorganic impurities is obtained. This purified lignin can be used in applications where a low content of inorganic impurities is required. Examples of such applications include in biofuel and as the starting material for carbon enriched materials, such as carbon fibers and carbon powder.

In the inventive method, the content of inorganic impurities in lignin is reduced first by removing inorganic impurities from the black liquor, resulting in lignin precipitated from the purified black liquor having a lower total content of inorganic impurities compared to lignin precipitated from non-purified black liquor. In particular, the content of certain inorganic impurities, such as aluminum, calcium, iron, magnesium, manganese, zinc, phosphorus and silica, that are hard to remove once lignin has been precipitated, is reduced in lignin precipitated from purified black liquor.

The content of inorganic impurities in the precipitated lignin is further reduced by mixing the precipitated lignin with an acidic solution. Mixing the precipitated lignin with an acidic solution will in particular reduce the content of water-soluble inorganic impurities, such as potassium and sodium, in the precipitated lignin. Thus, the content of inorganic impurities in lignin precipitated from purified black liquor and subsequently mixed with an acidic solution is lower compared to the content of inorganic impurities in lignin precipitated from non-purified black liquor and subsequently mixed with an acidic solution.

In one embodiment, the purified lignin obtained by the method according to the first aspect comprises a lower amount of aluminum, calcium, iron, magnesium, manganese, zinc, phosphorous and silica, compared to lignin precipitated from black liquor from which inorganic impurities have not been removed prior to lignin precipitation.

The term “total content of inorganic impurities” as used herein refers to the total amount of inorganic impurities, such as metals and other inorganic species, present in lignin. The content of each inorganic species is determined by elemental analysis, such as inductively coupled plasma-optical emission spectroscopy (ICP-OES). The total content of inorganic impurities is determined by summarizing the amounts of all individual inorganic species.

Step f) of the method according to the first aspect involves separating the obtained purified lignin from the acidic washing solution. In one embodiment, the separation involves filtration of the acidic solution to isolate the purified lignin from the acidic solution. In an alternative embodiment, the separation involves centrifuging.

In one embodiment, separation of precipitated lignin in step d) and/or separation of purified lignin in step f) is performed by filtration. A filter press or any other suitable equipment as known by a person skilled in the art may be used for the filtration.

The obtained purified lignin may be subjected to various treatments, such as washing, drying, pulverizing and heating after separation from the acidic solution. In one embodiment, the obtained purified lignin is washed after separation.

In one embodiment, the obtained purified lignin is dried after separation. Drying may be performed using any suitable means as known in the art. In one embodiment, the dried purified lignin is pulverized to obtain a lignin powder.

In one embodiment, the purified lignin is subjected to heat treatment. By heat treatment at a high temperature, a carbon enriched material may be obtained. The carbon enriched material obtained from the purified lignin will have a sufficiently low content of inorganic impurities such that it is suitable for use in energy storage applications.

### EXAMPLES

### Example 1 (Comparative)

Black liquor from a Softwood Kraft cook having a total dry solids content of 30.4%, a pH of 13.4 and a density of 1.22 g/cm³ was used. Lignin was precipitated from the black liquor by lowering the pH of the black liquor to 10.0 using carbon dioxide at a temperature of about 60° C. The precipitated lignin was separated using filtration and collected, and the content of individual inorganic species in the precipitated lignin was measured gravimetrically. The precipitated lignin was subsequently washed by mixing the precipitated lignin with sulfuric acid having a pH value of 2.5 in order to obtain washed lignin. The content of individual inorganic species in the washed lignin was measured using ICP-OES method after oxidation in hydrogen peroxide and subsequent wet digestion in a microwave oven with nitric acid. The results from the measurements are summarized in table 1.

### Example 2

A pre-precipitated lignin fraction was obtained by lowering the pH of the black liquor to 11.2 or 11.8 respectively by the addition of carbon dioxide. The same black liquor as in example 1 was used. Inorganic impurities were removed from the black liquor by filtering through a lignin cake formed out of the pre-precipitated lignin using a feed pressure of 6 bar (g) at a temperature between 50 and 55° C. The main lignin fraction was subsequently precipitated from the purified black liquor, separated, collected and washed as described in example 1. The content of individual inorganic species in the precipitated lignin and in the washed lignin were measured using ICP-OES method, as described for example 1. The results from the measurements are summarized in table 1.

TABLE 1
Content of inorganic impurities in lignin precipitated from black liquor (precipitated lignin)
and in the precipitated lignin after washing in an acidic solution (washed lignin). Pre-precipitated
at pH 11.2/11.8 refers to lignin precipitated from black liquor that has been purified by filtration
through a lignin fraction pre-precipitated at a pH of 11.2/11.8 respectively.

| | Al | Ca | K | Mg | Mn | Na | P | Si |
|---|---|---|---|---|---|---|---|---|
| Sample | (ppm) | (ppm) | (ppm) | (ppm) | (ppm) | (ppm) | (ppm) | (ppm) |
| comparative, | 45 | 152 | 5627 | 211 | 78 | 78352 | 46 | 252 |
| precipitated lignin | | | | | | | | |
| comparative, | 41 | 55 | 1642 | 63 | 24 | 20775 | 14 | 230 |
| washed lignin | | | | | | | | |
| pre-precipitated at pH | 21 | 40 | 9047 | 79 | 43 | 130070 | 23 | 222 |
| 11.2, precipitated lignin | | | | | | | | |
| pre-precipitated at pH | 28 | 19 | 2568 | 24 | 14 | 34683 | 9 | 159 |
| 11.2, washed lignin | | | | | | | | |
| pre-precipitated at pH | 37 | 68 | 5638 | 115 | 68 | 78541 | 25 | 236 |
| 11.8, precipitated lignin | | | | | | | | |
| pre-precipitated at pH | 13 | 19 | 1092 | 23 | 14 | 13254 | 6 | 67 |
| 11.8, washed lignin | | | | | | | | |

The examples show that the amounts of inorganic impurities that are otherwise difficult to remove from lignin, such as aluminum, calcium, magnesium, manganese, phosphorous and silicon, are lower in lignin that has been precipitated from purified black liquor than in lignin precipitated from black liquor without a purification step.

In view of the above detailed description of the present invention, other modifications and variations will become apparent to those skilled in the art. However, it should be apparent that such other modifications and variations may be effected without departing from the spirit and scope of the invention.

1. A method for purifying lignin, the method comprising the steps of:
a) providing an alkaline black liquor;
b) removing inorganic impurities from the alkaline black liquor so as to obtain a purified black liquor;
c) acidifying the purified black liquor to a pH value in a range of from 9 to 11 so as to precipitate a precipitated lignin;
d) separating the precipitated lignin from the purified black liquor that has been acidified;
e) mixing the precipitated lignin with an acidic solution so as to remove inorganic impurities from the precipitated lignin and to obtain a purified lignin; and
f) separating the purified lignin from the acidic solution.

2. The method according to claim 1, wherein the step of removing inorganic impurities from the alkaline black liquor comprises microfiltration or ultrafiltration of the alkaline black liquor.

3. The method according to claim 1, wherein the step of removing inorganic impurities from the alkaline black liquor comprises contacting the alkaline black liquor with a pre-precipitated lignin fraction so as to remove inorganic impurities from the alkaline black liquor to the pre-precipitated lignin.

4. The method according to claim 3, wherein the pre-precipitated lignin fraction is obtained by acidifying the alkaline black liquor to a pH value in a range of from 11 to 13, and
wherein the pH value used for acidifying the black liquor is higher than the pH value used for acidifying the purified black liquor in step c).

5. The method according to claim 3, wherein contacting the alkaline black liquor with the pre-precipitated lignin fraction comprises filtering the alkaline black liquor through the pre-precipitated lignin fraction.

6. The method according to claim 1, wherein the step of removing inorganic impurities from the alkaline black liquor comprises centrifuging the alkaline black liquor.

7. The method according to claim 1, wherein the separation of precipitated lignin in step d) is performed by filtration, and/or the separation of purified lignin in step f) is performed by filtration, or both.
